(19) United States
(12) Patent Application Publication
(10) Pub. No.: US 2006/0055298 A1
(43) Pub. Date: Mar. 16, 2006

(54) Spark plug for internal combustion engine

(75) Inventor: Keiji Kanao, Aichi-ken (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/222,769

(22) Filed: Sep. 12, 2005

(30) Foreign Application Priority Data
Sep. 15, 2004 (JP) 2004-268814

(51) Int. Cl. H01T 13/20

(52) U.S. Cl. 313/141

(57) ABSTRACT

The spark plug includes a mounting bracket, a tubular insulator held by the mounting bracket, a center electrode held in the insulator, a main ground electrode forming a main spark discharge gap with the tip end portion of the center electrode, and an auxiliary ground electrode forming an auxiliary spark discharge gap with the end portion of the insulator. The auxiliary ground electrode has such shape as to provide a space in which the flame core produced by the spark discharge taking place in the auxiliary spark discharge gap can grow.

### CROSS-REFERENCE TO RELATED APPLICATION

This application is related to Japanese Patent Application No. 2004-268814 filed on Sep. 15, 2004, the contents of which are hereby incorporated by reference.

### BACKGROUND OF THE INVENTION

1. Field of the Invention

The present invention relates to a spark plug for use in an internal-combustion engine of an automobile, a cogeneration apparatus, a high pressure gas feed pump, etc.

2. Description of Related Art

FIG. 7 shows a configuration of a typical conventional spark plug 9 used in an internal-combustion engine of an automobile. As shown in this figure, the spark plug 9 includes an insulator 92, a center electrode 93 held by the insulator 92, a mounting bracket 94 holding the insulator 92 in such a state that an end portion 921 of the insulator 92 juts out from the mounting bracket 94, and a main ground electrode 95 forming a spark discharge gap 911 with a tip end portion 931 of the center electrode 93.

In the spark plug 9 having the above described configuration, if combustion temperature is exceedingly low, and accordingly, the surface temperature of the insulator 92 is not high enough, there can occur the so-called “smoldering” phenomenon where carbon deposits on the surface of the insulator 92. The carbon deposited on the surface of the insulator 92 lowers the insulation resistance between the center electrode 93 and the mounting bracket 94, which may cause misfire.

As a technique to cope with the “smoldering”, it is known, as described in Japanese Patent No. 3140006, to provide a pair of auxiliary ground electrodes 96 which face the sides of the center electrode 93, to thereby form auxiliary spark discharge gaps 912 between the auxiliary ground electrodes 96 and the insulator 92. The carbon deposited on the surface of the insulator 92 is burnt down by spark discharges taking place in the auxiliary spark discharge gaps 912. Accordingly, the provision of the auxiliary ground electrodes 96 makes it possible to keep the surface of the insulator 92 clean.

It should be noted that the spark discharges in the auxiliary ground electrodes 96 are also expected to ignite the the internal combustion engine. To that end, it is necessary that a flame spreads into the combustion chamber from each of the auxiliary spark discharge gaps 912.

However, it often occurs that the core of the flame produced by the discharge in the auxiliary spark discharge gap 912, which lies between an inner angular portion 964 of an end surface 961 of the auxiliary ground electrode 96 and the end portion 921 of the insulator 92, is cooled by the auxiliary ground electrode 96, and as a result of which, the flame is constricted from growing. For such a reason, the auxiliary ground electrodes 96 have been insufficient in the function of assisting the ignition.

### SUMMARY OF THE INVENTION

The present invention provides a spark plug for an internal combustion engine comprising:

a mounting bracket having a mounting thread portion formed in an outer circumference thereof;

a tubular insulator held by the mounting bracket such that an end portion of the insulator juts out from the mounting bracket;

a center electrode held in the insulator such that a tip end portion of the center electrode juts out from the end portion of the insulator;

a main ground electrode forming a main spark discharge gap with the tip end portion of the center electrode; and

an auxiliary ground electrode forming an auxiliary spark discharge gap with the end portion of the insulator,

the auxiliary ground electrode having a base end surface joined to the mounting bracket, a tip end surface opposing the base end surface, an inner side surface joining the base end surface and the tip end surface and facing the end portion of the insulator, and an outer side surface joining the base end surface and the tip end surface and opposing the inner side surface,

the tip end surface and the inner side surface forming an inner angular portion, the tip end surface and the outer side surface forming an outer angular portion,

the auxiliary ground electrode having such a shape that a distance between the tip end surface thereof and a circumferential side surface of the end portion of the insulator increases towards the outer angular portion from the inner angular portion.

In the spark plug of the invention, the distance between the tip end surface of the auxiliary ground electrode and the circumferential side surface of the end portion of the insulator increases towards the outer angular portion from the inner angular portion, so that the auxiliary spark discharge gap has a shape expanding towards the back of the combustion chamber.

This shape provides a space in which the flame core produced by the spark discharge taking place in the auxiliary spark discharge gap can grow. Hence, with the spark plug of the invention, since the flame core produced by the spark discharge in the auxiliary spark discharge gap grows sufficiently large in the combustion chamber, the igniting performance of the internal combustion engine is improved.

### BRIEF DESCRIPTION OF THE DRAWINGS

In the accompanying drawings:

FIG. 1 is a half cross-sectional view of a spark plug according to a first embodiment of the invention;

FIG. 2 is a partial cross-sectional view of the spark plug according to the first embodiment of the invention showing an end portion thereof and its vicinity;

FIG. 3 is a partial cross-sectional view of a spark plug according to a second embodiment of the invention showing an end portion thereof and its vicinity;

FIG. 4 is a partial cross-sectional view of a spark plug according to a third embodiment of the invention showing an end portion thereof and its vicinity;

FIG. 5 is a graph showing a measured comparison for the spark position and combustion pressure between the spark plug according to the first embodiment of the invention and a conventional spark plug;

FIG. 6 is a graph showing a measured relationship between the combustion pressure and the angle θ which the end face of the auxiliary ground electrode forms with the side surface of the end portion of the insulator in the spark plug according to the first embodiment of the invention; and

FIG. 7 is a partial cross-sectional view of a conventional spark plug showing an end portion thereof and its vicinity.

### PREFERRED EMBODIMENTS OF THE INVENTION

In the below described embodiments of the invention, a direction along the center axis of the spark plug is referred to as an axial direction, a direction perpendicular to the center axis of the spark plug is referred to as a radial direction, and a distance along the direction perpendicular to the center axis of the spark plug is referred to as a radial distance.

### First Embodiment

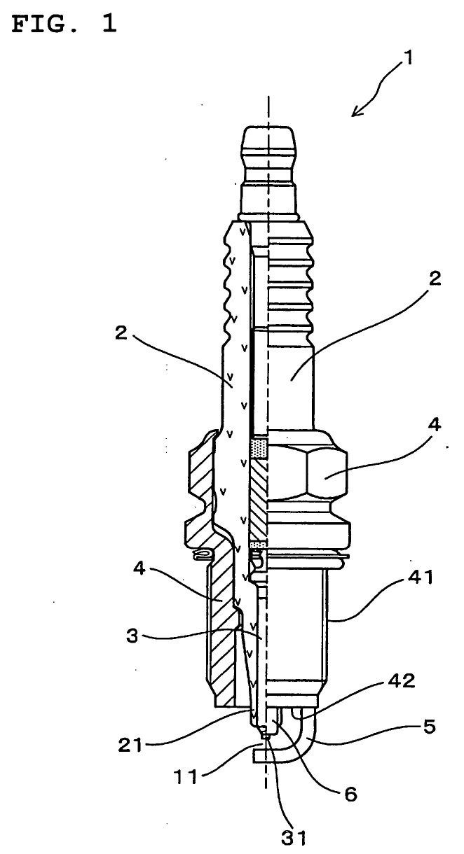

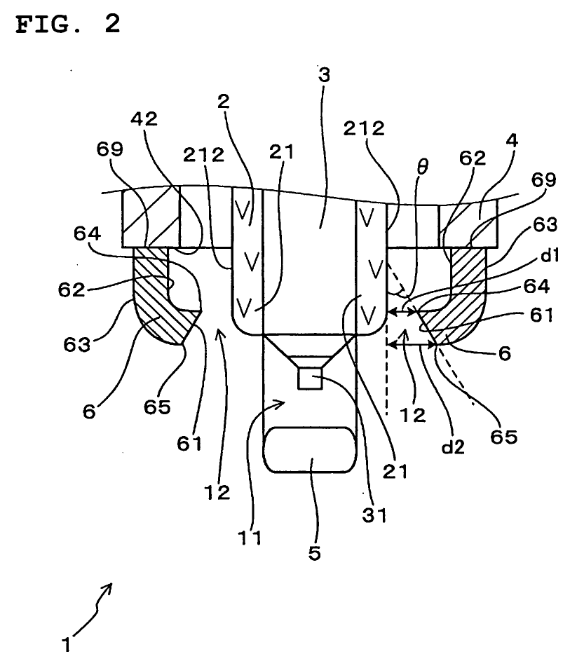

FIG. 1 is a half cross-sectional view of a spark plug 1 according to a first embodiment of the invention, and FIG. 2 is a partial cross-sectional view of the spark plug 1 showing an end portion (a portion to be inserted into the combustion chamber of an internal combustion engine) thereof and is vicinity. As shown in these figures, the spark plug 1 includes a mounting bracket 4 having a mounting thread portion 41 formed in an outer circumference thereof, an insulator 2 held by the mounting bracket 4 such that an end portion 21 of the insulator 2 juts out from the mounting bracket 4, and a center electrode 3 held by the insulator 2 such that a tip end portion 31 of the center electrode 3 juts out from the end portion 21 of the insulator 2. The spark plug 1 further includes a main ground electrode 5 forming a main spark discharge gap 11 with the tip end portion 31 of the center electrode 3, and a pair of auxiliary ground electrodes 6 forming auxiliary spark discharge gaps 6 with the end portion 21 of the insulator 2.

As shown in FIG. 2, each of the auxiliary ground electrodes 6 has a base end surface 69 joined to the mounting bracket 4, a tip end surface 61 opposing the base end surface 69, an inner side surface 62 joining the base end surface 69 and the tip end surface 61 and facing the insulator 2, and an outer side surface 63 joining the base end surface 69 and the tip end surface 61 and opposing the inner side surface 62. The cross section of the auxiliary ground electrodes 6 may be rectangular or round.

The tip end surface 61 and the inner side surface 62 form an inner angular portion 64. The tip end surface 61 and the outer side surface 63 form an outer angular portion 65. The auxiliary ground electrode 6 has such a shape that the distance between the tip end surface 61 thereof and a circumferential side surface 212 of the end portion 21 of the insulator 2 increases towards the outer angular portion 65 from the inner angular portion 64. Accordingly, the radial distance d1 between the inner angular portion 64 and the circumferential side surface 212 is smaller than the radial distance d2 between the outer angular portion 65 and the circumferential side surface 212.

The auxiliary ground electrode 6 extends from the end surface 42 of the mounting bracket 4 in the axial direction for a certain length, and curves towards the center electrode 3 at a certain point. That is, the auxiliary ground electrode 6 is J-shaped. The tip end surface 61 of the auxiliary ground electrode 6 is formed as an inclined plane facing the tip end portion 31 of the center electrode 3 by cutting the auxiliary ground electrode 6 at an angle oblique to its longitudinal axis. In this embodiment, the tip end surface 61 of the auxiliary ground electrode 6 is inclined to the circumferential side surface 212 of the end portion 21 of the insulator 2 by a certain angle (represented by θ in FIG. 1) larger than 15 degrees. The circumferential side surface 212 of the end portion 21 of the insulator 2 is parallel to the longitudinal axis of the spark plug 1.

Although, the spark plug 1 has the pair of the auxiliary ground electrodes 6 facing each other across from the center electrode 3, the spark plug 1 may have only one auxiliary ground electrode, or three or more auxiliary ground electrodes.

Next, the operation of the spark plug 1 is explained. As seen from FIG. 2, the auxiliary spark discharge gaps 12 are formed between the tip end surface 61 of the auxiliary ground electrodes 6 and the end portion 21 of the insulator 2. The distance between the tip end surface 61 of the auxiliary ground electrode 6 and the circumferential side surface 212 of the end portion 21 of the insulator 2 increases towards the outer angular portion 65 from the inner angular portion 64 as explained above. Thus, the auxiliary spark discharge gap 12 has a shape expanding towards the back of the combustion chamber.

This shape provides a space in which the flame core produced by the spark discharge taking place in the auxiliary spark discharge gap 12 can grow. Accordingly, with this embodiment, since the flame core produced by the spark discharge in the auxiliary spark discharge gap 12 grows large enough in the combustion chamber, the igniting performance of the internal combustion engine is improved.

It is desirable that the mounting thread portion 41 has a thread diameter not larger than 12 mm, so that the spark plug 1 can be made small to thereby allow greater flexibility in designing the internal combustion engine and radiator components, for example, to allow a larger diameter of an engine valve. The small thread diameter of the mounting screw portion 41 also eases bending work of the auxiliary ground electrode 6, because the bending amount or inclination of the auxiliary ground electrode 6 can be made small.

### Second Embodiment

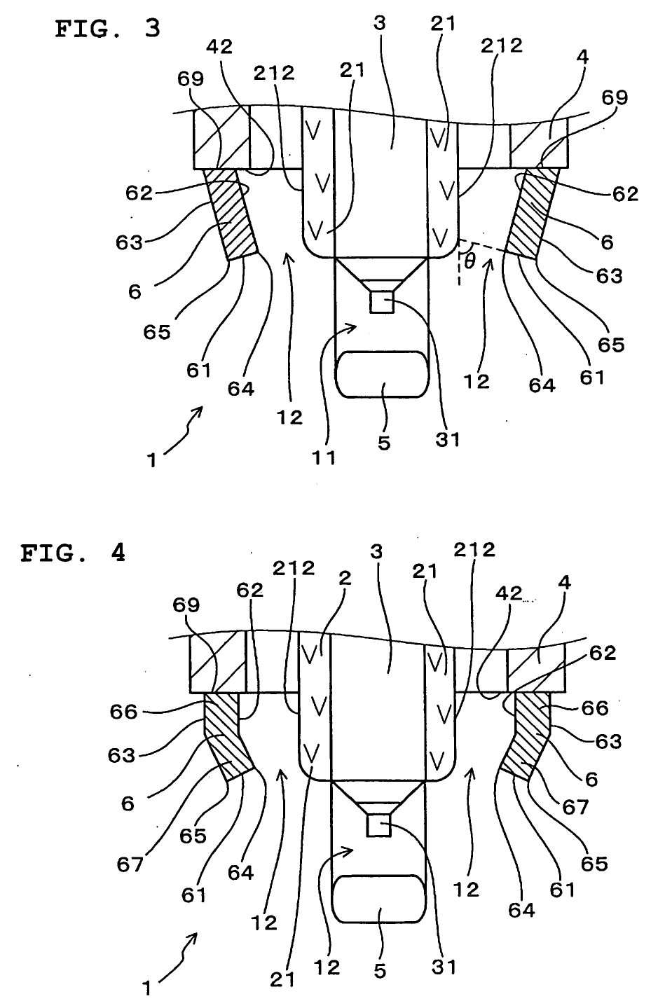

The second embodiment is different from the first embodiment in that the auxiliary ground electrode 6 is not curved, but has a straight shape in the second embodiment as shown in FIG. 3.

In the second embodiment, the auxiliary ground electrode 6 is joined to the end surface 42 of the mounting bracket 4 such that it inclines towards the center electrode 3, and the inner angular portion 64 and the outer angular portion 65 are made to have substantially a right angle edge. In this embodiment, the inclination of the auxiliary ground electrode 6 is set to such a value that the angle θ which the tip end surface 61 of the auxiliary ground electrode 6 forms with the circumferential side surface 212 of the end portion 21 of the insulator 2 becomes larger than 15 degrees.

The configuration of the second embodiment is the same as that of the first embodiment as for the rest.

With this embodiment, it is possible to reduce the production costs of the spark plug, because the auxiliary ground electrode 6 can be manufactured simply by cutting a bar of electrode material to a predetermined length, and any bending work is not therefore needed.

### Third Embodiment

The third embodiment is different from the first embodiment in that, as shown in FIG. 4, the auxiliary ground electrode 6 is constituted by a parallel portion 66 joined to the end surface 42 of the mounting bracket 4 and extending in the direction parallel to the circumferential side surface 212 of the end portion 21 of the insulator 2, and a slant portion 67 extending from the parallel portion 66 towards the center electrode 3.

The inner angular portion 64 and the outer angular portion 65 are made to have substantially a right angle edge. Also in this embodiment, the inclination of the slant portion 67 of the auxiliary ground electrode 6 is set to such a value that the angle θ which the tip end surface 61 of the auxiliary ground electrode 6 forms with the circumferential side surface 212 of the end portion 21 of the insulator 2 becomes larger than 15 degrees.

The configuration of the third embodiment is the same as that of the first embodiment as for the rest.

### Fourth Embodiment

The fourth embodiment is different from the first embodiment in that a noble metal chip is provided on the tip end surface 61 of the auxiliary ground electrode 6. In this embodiment, the auxiliary ground electrode 6 has such a shape that the radial distance between the surface of the noble metal chip and the circumferential side surface 212 of end portion 21 of the insulator 2 increases towards the outer angular portion 65 from the inner angular portion.

It is desirable that the noble metal chip has a melting point higher than 1500 degrees C., and contains not less than 50 weight percent of Pt as a primary component and at least one kind of additive. The additive may be Ir, Rh, Ni, W, Pd, Ru, or Re.

The configuration of the fourth embodiment is the same as that of the first embodiment as for the rest.

The spark plug 1 according to this embodiment has a long life, because the tip end surface 61 of the auxiliary ground electrode 6 exhibits excellent wear resistance. The tip end portion 31 of the center electrode 3 and the discharge surface of the main ground electrode 5 may be provided with such a noble metal chip.

### Experiment 1

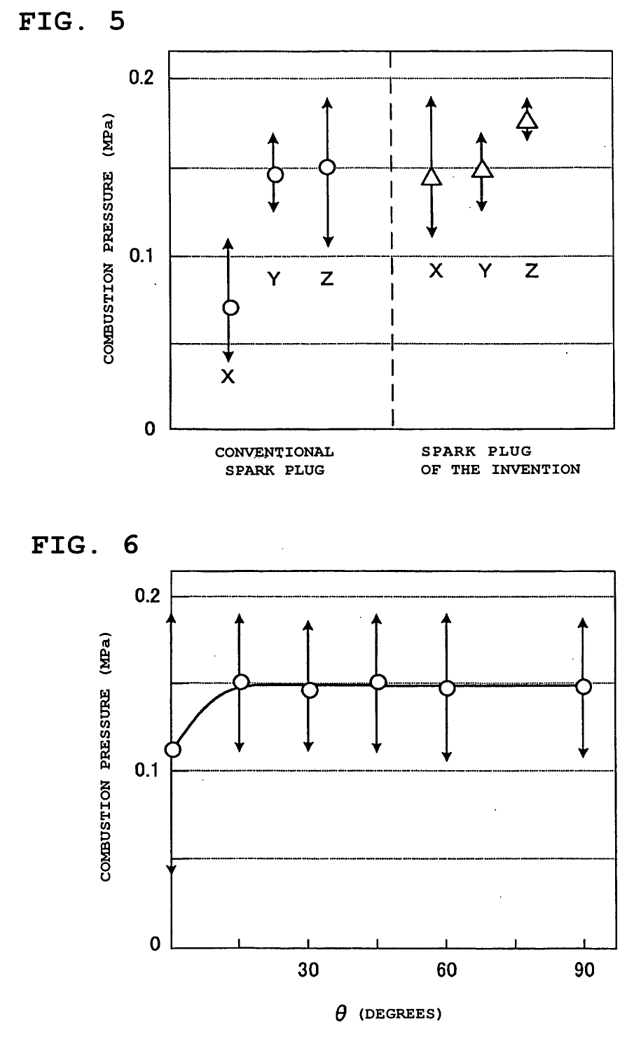

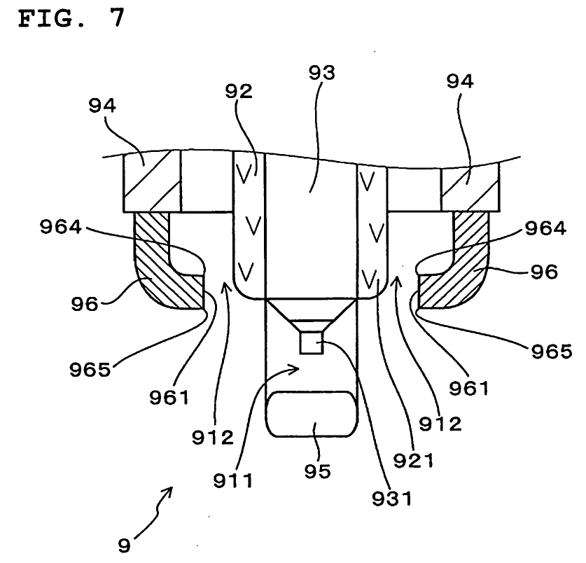

The graph of FIG. 5 shows a measured comparison for the spark position and combustion pressure between the spark plug 1 according to the first embodiment and the conventional spark plug 9 explained with reference to FIG. 7.

In this experiment, the main ground electrodes 5 and 95 were removed from the spark plug 1 and the spark plug 9, respectively, so that the spark discharge takes place in only the auxiliary spark discharge gap 12 or 912. The minimum widths of the auxiliary spark discharge gaps 12 and 912 were set at 0.5 mm, respectively. In the spark plug 1, the angle θ which the tip end surface of 61 the auxiliary ground electrode 6 forms with the circumferential side surface 212 of the end portion 21 of the insulator 2 was set at 30 degrees.

A 1.8 L four-cylinder visualization engine was used as the internal combustion engine in this experiment. The spark position and combustion pressure were observed for 100 consecutive ignitions while the engine was idling at 600 rpm.

In the graph of FIG. 5, the mark X represents sparks which took place at the inner angular portions 64 or 964 of the auxiliary ground electrodes 6 or 96, the mark Y represents sparks which took place at about the center of the tip end surface 61 or 961 of the auxiliary ground electrodes 6 or 96, and the mark Z represents sparks which took place at the inner angular portions 64 or 964 of the auxiliary ground electrodes 6 or 96, In the conventional spark plug 9, the number of the sparks in the category of the mark X was 38, the number of the sparks in the category of the mark Y was 29, and the number of the sparks in the category of the mark Z was 33. In the spark plug 1 according to the first embodiment of the invention, the number of the sparks in the category of the mark X was 71, the number of the sparks in the category of the mark Y was 21, and the number of the sparks in the category of the mark Z was 8.

Each of the two-headed arrows in the graph of FIG. 5 indicates a measured range of the combustion pressures. Also in this graph, each of the mark ∘ represents a mean value of the measured range of the combustion pressures in the conventional spark plug 9, and each of the mark Δ represents a mean value of the measured range of the combustion pressures in the spark plug 9 according to the first embodiment of the invention.

From this graph, it can be seen that the combustion pressure when the spark of the category X takes place is low in the conventional spark plug 9, whereas, in the spark plug 1 of the invention, the combustion pressure is sufficiently high even when the spark of the category X takes place. Hence, the spark plug 1 of the invention has an excellent igniting performance compared to the conventional spark plug 9, because the combustion pressure can be kept high even when the spark discharge takes place in only the auxiliary spark discharge gap 12.

### Experiment 2

The graph of FIG. 6 shows a measured relationship between the combustion pressure and the angle θ which the tip end face 61 of the auxiliary ground electrode 6 forms with the circumferential side surface 212 of the end portion 21 of the insulator 2. In this experiment, 6 spark plugs whose angle θ are 0, 15, 30, 45, 60, and 90 degrees, respectively, were prepared, and the combustion pressure was measured for each of these spark plugs under the condition similar to that in the Experiment 1.

As seen from this graph, the spark plugs whose angle θ are 15, 30, 45, 60, and 90 degrees, respectively, exhibit high combustion pressures.

However, another experiment shows that, if the angle θ is larger than 75 degrees, the auxiliary discharge gap tends to widen due to wear by the spark discharge therein. Since the spark discharge does not take place easily in the excessively widened discharge gap, it is preferable to set the angle θ smaller than 75 degrees. Accordingly, the angle θ is preferably set between 15 and 75 degrees.

Although the above described embodiments concern an internal combustion engine of an automobile, the present invention is also applicable to a cogeneration system, a high pressure gas feed pump, etc.

What is claimed is:

1. A spark plug for an internal combustion engine comprising:
a mounting bracket having a mounting thread portion formed in an outer circumference thereof;
a tubular insulator held by said mounting bracket such that an end portion of said insulator juts out from said mounting bracket;
a center electrode held in said insulator such that a tip end portion of said center electrode juts out from said end portion of said insulator;
a main ground electrode forming a main spark discharge gap with said tip end portion of said center electrode; and
an auxiliary ground electrode forming an auxiliary spark discharge gap with said end portion of said insulator,
said auxiliary ground electrode having a base end surface joined to said mounting bracket, a tip end surface opposing said base end surface, an inner side surface joining said base end surface and said tip end surface and facing said end portion of said insulator, and an outer side surface joining said base end surface and said tip end surface and opposing said inner side surface,
said tip end surface and said inner side surface forming an inner angular portion, said tip end surface and said outer side surface forming an outer angular portion,
said auxiliary ground electrode having such a shape that a distance between said tip end surface thereof and a circumferential side surface of said end portion of said insulator increases towards said outer angular portion from said inner angular portion.

2. The spark plug according to claim 1, wherein said auxiliary ground electrode has a bar-like shape.

3. The spark plug according to claim 1, wherein said inner and outer angular portions have substantially a right angle edge.

4. The spark plug according to claim 1, wherein said tip end surface of said auxiliary ground electrode is inclined to said circumferential side surface of said end portion of said insulator by not less than 15 degrees.

5. The spark plug according to claim 1, wherein said tip end surface of said auxiliary ground electrode is inclined to said circumferential side surface of said end portion of said insulator by an angle in a range between 15 degrees and 75 degrees.

6. The spark plug according to claim 1, wherein said mounting thread portion of said mounting bracket has a thread diameter not larger than 12 mm.

7. The spark plug according to claim 1, wherein a noble metal chip is provided on said tip end surface of said auxiliary ground electrode.

8. The spark plug according to claim 7, wherein said noble metal chip has a melting point higher than 1500 degrees C., and contains not less than 50 weight percent of Pt as a primary component.

9. The spark plug according to claim 8, wherein said noble metal chip contains at least one additive selected from the group consisting of Ir, Rh, Ni, W, Pd, Ru, and Re.
